(19) United States
(12) Patent Application Publication
(10) Pub. No.: US 2025/0205813 A1
(43) Pub. Date: Jun. 26, 2025

(54) LASER MACHINING PROCESS USING A SCANNER OPTICAL SYSTEM

(71) Applicant: TRUMPF Werkzeugmaschinen SE + Co. KG, Ditzingen (DE)

(72) Inventors: Axel Paul, Ditzingen/Heimerdingen (DE); Bernd Renz, Benningen am Neckar (DE); Gerhard Hammann, Korntal- Münchingen (DE); Stefan Leinberger, Göppingen (DE); Alexander Huber, Ölbronn- Dürrn (DE)

(21) Appl. No.: 19/079,505

(22) Filed: Mar. 14, 2025

Related U.S. Application Data
(63) Continuation of application No. PCT/EP2023/074923, filed on Sep. 11, 2023.

(30) Foreign Application Priority Data
Sep. 16, 2022 (DE) 10 2022 123 730.3

(51) Int. Cl. B23K 26/082; B23K 26/06; B23K 26/14; B23K 26/38

(52) U.S. Cl. CPC B23K 26/082; B23K 26/0643; B23K 26/0648; B23K 26/1464; B23K 26/38

(57) ABSTRACT

A laser machining head includes a scanner arranged in a beam path of the laser machining head. The scanner includes a scanner mirror that is tiltably mounted about two rotational axes. The scanner is arranged in the laser machining head such that a laser beam which runs through the beam path is incident on the scanner mirror at an angle of incidence α of at most 30° relative to a surface normal of the scanner mirror.

### CROSS REFERENCE TO RELATED APPLICATIONS

This application is a continuation of International Application No. PCT/EP2023/074923 (WO 2024/056615 A3), filed on Sep. 11, 2023, and claims benefit to German Patent Application No. DE 10 2022 123 730.3, filed on Sep. 16, 2022. The aforementioned applications are hereby incorporated by reference herein.

### FIELD

Embodiments of the present invention relate to the field of laser machining of workpieces, preferably the laser cutting of metallic workpieces. In particular, embodiments of the invention relate to a laser machining head having a scanner unit for deflecting the laser beam within the laser machining head.

### BACKGROUND

Techniques for deflecting a laser beam in a laser machining head by means of scanner devices are known, for example, from WO2019145536A1. Furthermore, systems are also known in which the laser beam is deflected in two spatial directions using only one movably mounted mirror. Examples of such single-mirror scanners are described in DE10027148A1 and EP4000789A2.

There exist fundamental limitations when using laser scanners for the machining of material with regard to the speed of movement of the beam-deflecting optical elements (in particular the scanner mirrors), as well as with regard to process stability with increasing laser power, in particular due to the increasing thermal load on the optical elements. The susceptibility of the scanner systems to soiling also plays an important role in this context.

### SUMMARY

Embodiments of the present invention provide a laser machining head. The laser machining head includes a scanner arranged in a beam path of the laser machining head. The scanner includes a scanner mirror that is tiltably mounted about two rotational axes. The scanner is arranged in the laser machining head such that a laser beam which runs through the beam path is incident on the scanner mirror at an angle of incidence α of at most 30° relative to a surface normal of the scanner mirror.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic perspective view of a laser cutting system for laser beam cutting according to some embodiments;

FIG. 2a shows a schematic representation of a laser cutting head according to some embodiments;

FIG. 2b shows a schematic representation of a laser cutting head according to some embodiments;

FIG. 3a shows a sectional view of a scanner unit according to some embodiments; and

FIG. 3b shows a further sectional view of the scanner unit as shown in FIG. 3a according to some embodiments.

### DETAILED DESCRIPTION

Embodiments of the present invention can make an increase in the deflection speed of a laser beam possible by a scanner device within a laser machining head, in particular within a laser cutting head. At the same time, the susceptibility of the sensitive scanner equipment to high laser powers in the kW and multi kW range can be reduced.

Embodiments of the invention provide a laser machining head, comprising a scanner unit which is arranged in a beam path of the laser machining head and which has a scanner mirror that is tiltably mounted about (at least) two rotational axes. A laser machining head is typically part of a laser machining system, wherein a laser beam is focused via the laser machining head and directed onto a workpiece to be machined. The tilting movement allows a laser beam incident on the scanner mirror to be deflected during operation of the laser machining head. A predefined tilt angle of the scanner mirror about each of the rotational axes can be at most ±2°, preferably at most ±0.3°, about the rest position.

The scanner unit is arranged in the laser machining head such that a laser beam which runs through the beam path is incident on the scanner mirror at an angle of incidence of at most 30°, preferably at most 22.5°, more preferably at most 15°, relative to a surface normal of the scanner mirror. The predetermined angle of incidence of the laser beam on the scanner mirror can be relative to the rest position (or zero position) of the scanner mirror. In other words, the angle of incidence of the laser beam on the scanner mirror during operation of the laser machining head can be a maximum of 32°, preferably a maximum of 24.5°, more preferably a maximum of 17°, if the maximum deflection of the scanner mirror with respect to the rest position is 2°.

Due to the reduced angle of incidence of the laser beam on the scanner mirror, the projection of the laser beam on the scanner mirror can be kept small. Due to the comparatively compact beam spot, the scanner mirror can be smaller in size compared to systems with larger angles of incidence, which also reduces its mass. The lower the mass of the scanner mirror, the faster it can be accelerated or decelerated, thus the greater the dynamics of the scanner unit and the higher the potential deflection speed of the laser beam.

According to a preferred variant, the laser machining head further comprises a collimation unit which is designed to collimate a diverging laser beam entering the beam path. The collimation unit can preferably be a collimation lens, which is preferably arranged after the entry of the diverging laser beam in the beam path of the laser machining head. Downstream of the collimation unit, the laser machining head can have a deflection unit which is designed to deflect the collimated laser beam onto the scanner mirror such that the collimated laser beam is incident on the scanner mirror at the predetermined angle of incidence. The deflection unit can preferably be a deflection mirror. The deflection mirror can preferably be arranged at a predetermined, fixed angle in the beam path of the laser machining head. Downstream of the scanner unit, the laser machining head can also have a focusing unit, in particular a focusing lens, which is designed to receive the laser beam deflected by the scanner unit and focus it on a target object. In particular, the target object can be a plate-shaped or tubular, particularly metallic, workpiece. For example, the laser beam can be focused on the surface of the workpiece. The beam entry and beam exit of the beam path in the laser machining head are typically arranged parallel or perpendicular to one another. By arranging the deflection unit in the beam path of the laser machining head, the predetermined angle of incidence on the scanner mirror can be achieved.

The collimation device can preferably have a collimation focal length of f≤100 mm, preferably f≈70 mm.

Preferably, the collimation unit can be arranged in the laser machining head so as to be displaceable in a direction longitudinally and/or transversely to the beam path. Alternatively or additionally, the deflection unit can be rotatably or pivotably mounted in the laser machining head. The laser beam can be fed to the optical arrangement by means of a fiber optic cable. The interface between the fiber optic cable and the optical arrangement, which can be designed in particular as a plug socket, can also be arranged so as to be displaceable. Due to the adjustable arrangement of the input interface, the collimation unit and/or the deflection unit, the laser beam, in particular the beam focus of the laser beam, can be precisely aligned with a center of the scanner mirror. This supports an aperture design of the scanner mirror with narrow tolerances, which has a favorable influence on the size and thus also the mass of the scanner mirror. In particular, the input interface of the laser beam and/or the collimation unit can be displaced vertically or laterally with respect to the beam path and/or the deflection unit can be rotatably mounted. The scanner unit can preferably be arranged fixed within the laser machining head, in particular on an axis defined by a beam exit opening of the laser machining head (in particular a cutting nozzle). Alternatively, the scanner unit can also be arranged so as to be displaceable and/or rotationally mounted in the laser machining head.

In addition to the variants described above, the laser machining head can preferably further comprise a diverging unit or beam diverging unit, in particular a diverging lens. The diverging lens can preferably be designed as a negative lens. The diverging unit can be arranged between the scanner unit and the focusing unit. The diverging unit can preferably have a focal length between f=−40 mm and f =−200 mm, in particular of f ≈−50 mm. Such an arrangement with a diverging unit or beam diverging unit can be advantageous for setting a predetermined imaging ratio while maintaining a relatively small beam diameter in front of the beam diverging unit. A small beam diameter in turn favors the design of a small scanner mirror aperture. If the laser machining head is designed as a laser cutting head for laser flame cutting or laser fusion cutting, for example, it may be desirable for the overall optical assembly to have an imaging ratio of 1.5. When using a collimation unit with a comparatively short focal length (such as f=70 mm), this would result in several design conflicts when using a regular and necessarily equally short focal length focusing lens (such as f=105 mm). The workpiece-side cutting width of a focusing lens assembly comprising the diverging unit and the subsequent focusing unit can therefore preferably be designed such that the last optical element has a sufficiently large design distance from the cutting nozzle of the laser cutting head.

The diverging unit can be arranged in the laser machining head so as to be displaceable longitudinally to the beam path, preferably via motorized displacement. This makes it easy to change the focus position of the laser beam. A transmission ratio between the displacement of a diverging unit designed as a negative lens can be selected, for example, such that a longitudinal displacement of the negative lens by ±5 mm causes a displacement of the focus position by +10 mm to −30 mm.

The scanner unit can preferably be arranged suspended in the laser machining head. In other words, the reflective surface of the scanner mirror can point at least partially downwards (in the direction of gravity) in a preferred machining position during operation of the laser machining head. This suspended arrangement of the scanner unit in the laser machining head can reduce the susceptibility of the scanner unit to soiling.

The collimation unit can preferably be designed as a collimation lens. The collimation lens can preferably be arranged upright in the laser machining head. It is understood that this specification refers to a preferred orientation of the laser machining head during operation of the laser machining head. An “upright” or vertical arrangement of the collimation lens is generally less susceptible to soiling than a horizontal arrangement.

As mentioned above, the laser machining head can comprise a connection socket for the entry of the laser beam into the beam path of the laser machining head. The connection socket can preferably be arranged horizontally or directed downwards on the laser machining head. Again, the positional description is related to the orientation of the laser machining head in a preferred operating state. A horizontal orientation of the connection socket is particularly preferable in this context, as this has proven to be less susceptible to soiling in practice. In addition, a horizontal orientation of the connection socket favors an upright arrangement of the collimation lens. Overall, it may therefore be preferable if the scanner unit is integrated into the laser machining head in a so-called “delta convolution”. In this regard, the connection socket is arranged perpendicular to the exit opening of the laser beam from the laser machining head. After entering via the connection socket, the laser beam is collimated and then deflected twice via the deflection unit (for example by 60°) and the scanner unit (for example by 30°).

As also mentioned above, the laser machining head can preferably be designed as a laser cutting head. As a laser cutting head, the laser machining head comprises at least one cutting nozzle and a process gas supply, wherein the laser beam is directed together with a process gas through the cutting nozzle onto the object to be machined, in particular a plate-shaped or tubular, preferably metallic, workpiece, and wherein the laser beam is movable through the scanner unit within an exit opening of the cutting nozzle. The movement interval with which the laser beam can be moved within the exit opening of the cutting nozzle can be up to 3 mm, preferably up to 2.5 mm in a direction transverse to the longitudinal axis of the nozzle. Such small beam deflections can be achieved by means of very small movements of the scanner mirror. The small mirror movements also limit the elliptical expansion of the beam projection on the mirror surface. This, in turn, allows the mirror dimensions and thus the mirror mass to be kept small, which increases the dynamics and speed of the mirror movement.

Embodiments of the invention also provide a scanner unit for a laser machining head. The scanner unit comprises a scanner mirror. The scanner mirror can preferably have a circular or approximately circular cross-section. The scanner unit also comprises a drive unit for tilting the scanner mirror about (at least) two rotational axes. The rotational axes can preferably be arranged perpendicular to one another.

Furthermore, the scanner unit comprises an aperture which is arranged on a reflection side of the scanner mirror facing a laser beam during operation of the scanner unit, wherein the aperture has a funnel-shaped inner wall, and wherein an angle of inclination of the inner wall is at most 30°, preferably at most 22.5°, more preferably at most 15° relative to a surface normal of the scanner mirror. The design of the aperture, for example, serves to intercept scattered radiation and to limit the projection of an incoming laser beam that is incident on the scanner mirror. Furthermore, the drive unit is shielded from incoming laser beams and thus protected. Overall, this creates the conditions for keeping the cross-section of the scanner mirror small, thereby reducing its mass and increasing the speed of the mirror movements.

The scanner mirror together with the frame and the drive unit can, for example, be designed as described in EP4000789A2, wherein the magnet pairs of the scanner drive are preferably arranged on the mirror frame.

The aperture is preferably made of a material with good heat conduction properties, such as a metal or metal alloy. In particular, the aperture can be made of steel. In this way, the aperture can also be used to remove heat that enters the system through scattered radiation, for example. The frame of the scanner mirror and the scanner drive can thus be protected from overheating.

The aperture of the scanner mirror can preferably be larger than the projection surface of the laser beam on the reflective surface by a factor of 1.2 to 1.8, preferably by a factor of 1.5, wherein the second moment method can be used, for example, to determine the projection surface. The aperture of the scanner mirror is determined in particular by the inner diameter of the mirror frame in the present case. The preferred minimum size of the aperture of the scanner mirror compared to the projection surface of the laser beam can prevent diffraction effects and heating of the mirror frame due to edge fields.

In order to ensure freedom of movement of the scanner mirror, the aperture is spaced apart from the surface (reflective surface) of the scanner mirror by a gap. The gap should preferably be kept as small as possible and can, for example, be <10 mm, preferably ≤1.5 mm, in a neutral position or rest position of the scanner mirror. By minimizing the gap, the shielding effect of the aperture can be maximized.

The aperture preferably has an aperture opening that is smaller than an aperture of the scanner mirror. In this manner, the shielding of the mirror frame and the drive unit can be ensured even in the event of a misaligned laser beam incidence. Preferably, the aperture of the scanner mirror and the aperture opening can each have a circular contour, wherein the aperture of the scanner mirror is larger than the minimum inner diameter of the aperture opening. The aperture of the scanner mirror can be determined in particular by the inner diameter of the mirror frame in which the scanner mirror is mounted.

The scanner mirror can preferably comprise a mirror substrate made of a transparent material, in particular of quartz glass. A residual transmission of laser radiation through the scanner mirror, which is unavoidable when a laser beam is incident on the reflective surface, can thus be directed to the rear side of the scanner mirror in a targeted manner. This prevents lateral heat dissipation in the direction of the mirror frame and the drive unit. The mirror substrate preferably has a thickness to diameter ratio of at most 1:10. This ensures the necessary rigidity of the scanner mirror. For example, the scanner mirror can have a diameter of 25 mm and a thickness of 2.5 mm.

The scanner mirror can also have an oxidic interference coating.

The scanner unit can further have a heat dissipation element which is arranged at a rear side of the scanner mirror, wherein the heat dissipation element is spaced apart from the rear side of the scanner mirror or from the frame mechanism by a gap just large enough to ensure free tilting of the scanner mirror together with the frame mechanism about the rotational axes. The gap between the heat dissipation element, which can also be referred to as a heat sink or cooling element, is preferably no more than 3 mm, more preferably no more than 1 mm, for example about 0.8 mm. In this way, on the one hand, the freedom of movement of the scanner mirror is not impaired and, on the other hand, heat dissipation from the scanner mirror via the heat dissipation element is enabled by free or forced convection. The heat dissipation element preferably has a conical section which is adjoined by a cylindrical section, wherein the cylindrical section is arranged in a recess formed by the rear side of the scanner mirror and by the mirror frame in which the scanner mirror is mounted or fixed. A lateral distance between the heat dissipation element and the mirror frame can preferably be at most 3 mm, more preferably at most 1 mm, for example approx. 0.8 mm. The heat dissipation element is preferably made of a material with good heat conduction properties, in particular a metal or metal alloy. The heat dissipation element is preferably made of steel. The heat dissipation element helps to efficiently dissipate heat from the scanner mirror and, in particular, to protect the filigree mirror frame and the drive unit (see EP4000789A2) from damage due to thermal overload.

According to another preferred variant, the aperture and/or the heat dissipation element can be actively cooled. For example, the aperture and/or the heat sink can each have one or more cooling channels, wherein a cooling fluid can flow through the cooling channels. Active cooling allows the heat input into the scanner unit due to unwanted irradiation—such as scattered light in the beam path, directional reflections from optical interfaces or process feedback—to be dissipated even more efficiently.

Furthermore, a cooling gas can be circulated in the gap between the heat dissipation element and the unit composed of the scanner mirror and mirror frame to further improve the cooling of the components.

In order to monitor its operating status, the scanner unit can be monitored without contact using thermal sensors, such as thermopiles. The thermopile can be used, for example, to monitor the rear side of the scanner mirror or the frame mechanism or the suspension of the scanner mirror for thermal changes. With respect to monitoring the frame mechanism, the area to be observed can preferably be blackened in order to increase and define the radiation emission at this point. Alternatively or additionally, in order to monitor the operating status of the scanner unit, a scattered light diode can be arranged in the beam path of the incident laser beam, which monitors the beam path and can very quickly detect the onset of contamination on the surface of the scanner mirror. In the event of a particle burn-in, the measurement level of the scattered light diode rises significantly and abruptly. The scattered light diode can preferably be aligned vertically or essentially vertically to the reflective surface of the scanner mirror.

Embodiments of the invention also provide a laser machining system, in particular a laser cutting system. The laser machining system comprises at least: a laser beam source for providing a laser beam and a laser machining head according to one of the variants described above. The laser beam has a power of at least 0.3 kW, in particular several kW (for example at least 4 kW or even 10 kW or more). Furthermore, a beam parameter product of the laser beam (when entering the laser machining head) is at most 4 mm*mrad, preferably at most 2.5 mm*mrad.

By using the laser machining head with the scanner unit, the laser machining system according to embodiments of the invention is particularly suitable for deflecting high-brilliance laser beams in the high-power range.

A solid-state laser is preferably used as the laser beam source, in particular a disk laser or a fiber laser. However, CO₂ lasers or diode lasers can also be used.

The beam quality of the laser beam and the collimation focal length of the collimation unit can preferably be selected such that the diameter of the collimated laser beam and thus also the diameter of the beam projection on the surface of the scanner mirror is kept small. For example, the beam parameter product can be around 2.5 mm*mrad with a collimation focal length of f≈70 mm.

Embodiments of the invention also provide a method for laser beam cutting, in which a laser machining beam is directed together with a process gas through the cutting nozzle of a laser cutting head onto the surface of a workpiece to be machined, wherein a secondary movement of the laser beam within the cutting nozzle is superimposed on a primary advance movement of the laser cutting head, and wherein the laser beam for generating the secondary movement within the laser cutting head is directed onto a scanner mirror tiltable about (at least) two rotational axes such that an angle of incidence of the laser beam on the scanner mirror is at most 30°, preferably at most 22.5°, more preferably at most 15° relative to a surface normal of the scanner mirror.

As described above, embodiments of the present invention offer advantages, in particular for laser cutting, in terms of dynamics, contour accuracy, repeatability, susceptibility to soiling, compactness and thermal resistance with respect to the deflection of the laser beam within the cutting nozzle compared to the systems previously known from the prior art, in particular compared to previous single-mirror scanners.

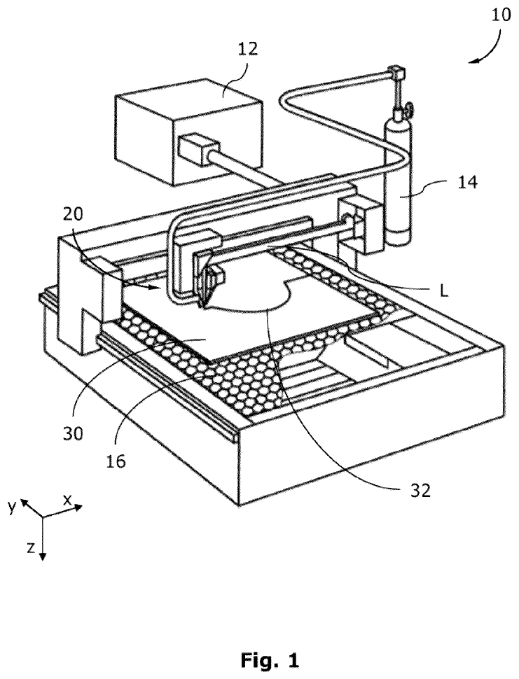

FIG. 1 shows a laser machining system in the form of a laser cutting system 10. The laser cutting system 10 comprises a laser beam source 12. The laser beam source 12 can be a CO₂ laser, a solid-state laser or a diode laser. Even if the present illustration shows a CO₂ laser configuration in which the generated laser beam L is guided to the laser machining head—in this case a laser cutting head 20—via deflection mirrors, solid-state lasers, in particular disk or fiber lasers, can in principle also be considered as preferable beam sources. In solid-state lasers, the laser beam 20 is usually transported to the laser cutting head 20 by means of an optical fiber (not shown in FIG. 1) and fed into the laser cutting head 20 via a connection socket.

The laser cutting system 10 further comprises a cutting gas supply 14, here in the form of a gas cylinder 14, via which a cutting gas, which generally contains nitrogen and/or oxygen, is transported via a line to the laser machining head 20 and, together with the laser beam L, is directed under a predetermined pressure through a cutting nozzle onto a workpiece 30 to be machined—in this case a plate-shaped workpiece. The workpiece 30 is mounted on a workpiece support 20 for machining by the machining beam consisting of the laser beam L and cutting gas jet. The workpiece 30, which is preferably a metallic workpiece 30, is melted locally by a relative movement between the workpiece 30 and the laser cutting head 20 and the resulting melt is expelled downwards such that a kerf 32 is formed in the workpiece 30. The laser cutting system 10 further comprises a control device which is programmed to move the cutting head 20 in accordance with a cutting contour relative to the workpiece 30.

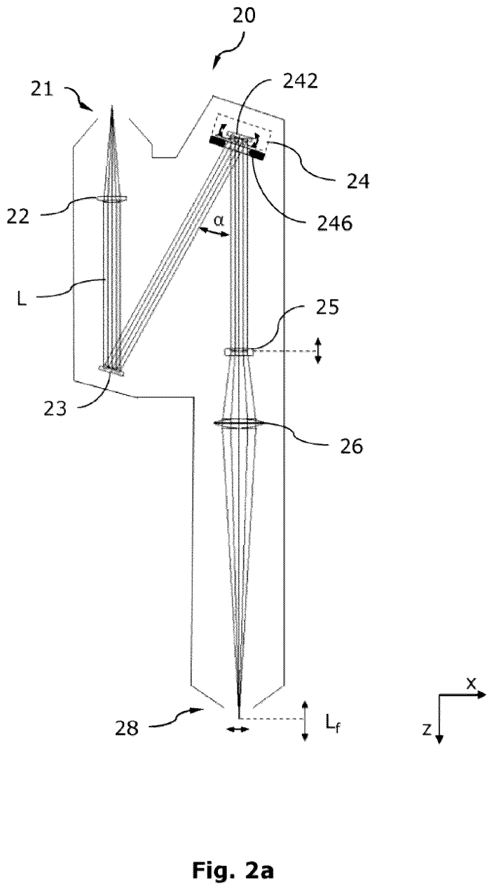

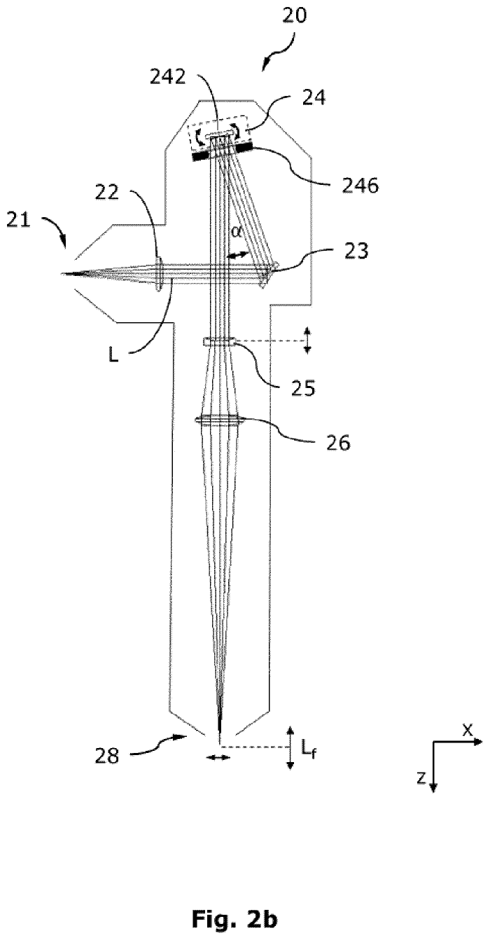

FIG. 2a schematically shows a laser cutting head 20 according to embodiments of the invention with a beam path in so-called “Z convolution”. The beam path is determined by an optical arrangement within the laser cutting head 20. The laser beam L enters the laser cutting head 20 through an entry opening 21. Preferably, the entry opening 21 can be designed as a connection socket for a fiber optic cable, via which the laser beam L is transported from a laser beam source to the laser cutting head 20. The diverging laser beam L emerging from the fiber optic cable is collimated by means of a collimation lens 22. The collimated laser beam L is then deflected via a deflection mirror 23 such that it is directed at a predefined angle of incidence onto the scanner mirror 242 of a scanner unit 24, which is arranged suspended in the laser cutting head 20. The scanner unit 24 is designed to tilt the scanner mirror 242 about two rotational axes with a comparatively small movement interval of up to ±2°, preferably up to ±0.3°, relative to a rest position. The scanner unit 24 also comprises an aperture 246, which is arranged in front of the scanner mirror 242 and shields the sensitive scanner mechanism from unwanted irradiation. The laser beam L is deflected at the scanner mirror 242 by an angle α which is at most 60°, preferably at most 45°, more preferably at most 30°, i.e., twice the angle of incidence according to embodiments of the invention, and directed onto an exit opening 28 of the laser cutting head 20. The deflection may vary slightly depending on the tilted position of the scanner mirror 242. On its way to the exit opening 28, which is preferably designed as a cutting nozzle, the laser beam L is first diverged by a negative lens 25 and then focused by a focusing lens 26 in the direction of the exit opening 28, via which it leaves the laser cutting head 20 together with a cutting gas jet (not shown) and is directed as a cutting beam onto a workpiece to be machined.

Due to the controlled tilting of the scanner mirror 242, the laser beam L can be deflected very quickly in a plane (here the x-y plane) transverse to the exit direction in a predetermined movement interval within the exit opening 28, i.e., within the cutting nozzle. A comparatively small and fast secondary movement of the laser beam can therefore be superimposed on the primary advance movement of the cutting beam during a cutting process. The cutting process can be influenced in a targeted manner by this superimposed secondary oscillating movement or scanner movement of the laser beam L, for example the kerf can be widened in places or the cutting front inclination can be changed.

The plug receptacle of the plug socket at the entry opening 21 of the laser cutting head 20 and/or the collimation lens 22 can be displaceable transversely to the beam path (here in the X direction). Furthermore, the deflection mirror 23 can be rotationally mounted and thus exhibit an inclination adjustment. This allows the laser beam L to be precisely aligned with a center of the scanner mirror 242. The negative lens 25 can be mounted so as to be displaceable along the beam path (here in the Z direction). By displacing the negative lens 25 in the Z direction, the focus position L_{f} of the laser beam can be easily changed.

FIG. 2b schematically shows a laser cutting head 20 according to embodiments of the invention which differs from the laser cutting head 20 according to FIG. 2a by the arrangement of the optical elements and thus by the course of the beam path. The beam path shown in FIG. 2b corresponds to a so-called “delta convolution”. The main difference to the Z convolution according to FIG. 2a is the orientation of the entry opening 21 perpendicular (and not parallel) to the exit opening 28. A horizontal arrangement of the entry opening 21 is generally less susceptible to contamination than a vertical arrangement. Due to the horizontal arrangement of the entry opening 21, the collimation lens 22 is oriented upright in the laser cutting head 20. An upright arrangement of the collimation lens 22 is also less susceptible to contamination, as particles cannot be deposited on the lens surface as easily.

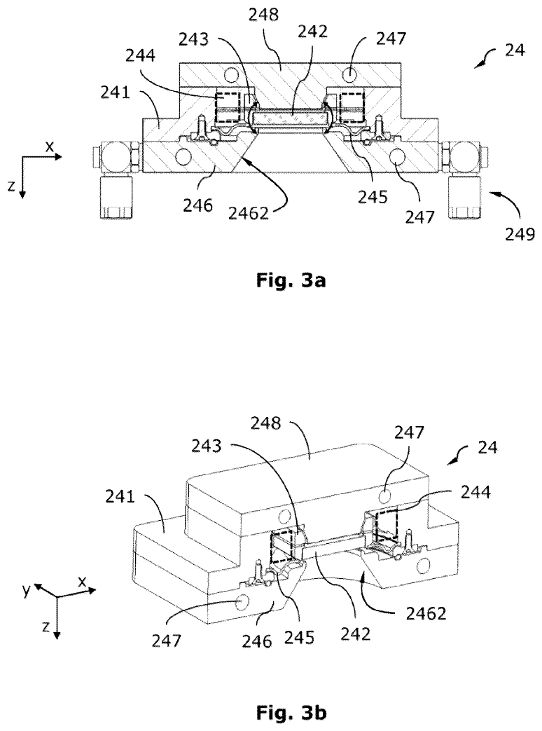

FIGS. 3a and 3b each show a scanner unit 24 according to embodiments of the invention in a sectional view. The scanner unit 24 comprises a scanner mirror 242, which is laterally mounted in a mirror frame 243. The unit consisting of the scanner mirror 242 and mirror frame is, in turn, movably mounted in a frame 241 via a mechanical suspension. For example, the mirror frame 243 can be suspended at four locations evenly distributed around its circumference by a solid joint. A drive unit 244 (indicated here by dashed boxes) is designed to tilt the mirror frame 243 together with the scanner mirror 242 about at least two rotational axes, preferably oriented perpendicular to one another, at a high frequency. The scanner mirror 242 together with the mirror frame 243 and the drive unit 244 can, for example, be designed as described in EP4000789A2, wherein the magnet pairs of the scanner drive can preferably be arranged on the mirror frame 243.

The scanner unit 24 further comprises an aperture 246 having a funnel-shaped inner wall 245, wherein an angle of inclination of the inner wall 245 is at most 30°, preferably at most 22.5°, more preferably at most 15° relative to a surface normal of the scanner mirror 242 (in a rest position of the scanner mirror 242). The smallest opening diameter of the aperture 246 on the side facing the scanner mirror 242 is smaller than the aperture of the scanner mirror 242. In this way, the mirror frame 243 and the scanner drive 244 can be effectively shielded by the aperture and protected from unwanted irradiation. A heat dissipation unit 248 in the form of a heat sink 248 is arranged at the rear side of the scanner mirror 242. The aperture 246 and the heat sink 248 are connected to one another by the lateral frame 241 of the scanner unit 24. A resilient sealing membrane 245 is arranged between the mirror frame 243 and the lateral frame 241 in order to protect the drive unit from soiling.

The aperture 246 and the heat sink 248 are each spaced apart from the scanner mirror 242 and the mirror frame 243 by a narrow gap to ensure their freedom of movement when tilted. At the same time, the distances between the aperture 242 and/or the heat sink 248 and the scanner mirror 242 and the mirror frame 243 are kept as small as possible in order to ensure efficient heat dissipation. In order to improve the heat dissipation from the scanner mirror 242 and/or the mirror frame 243, the aperture 246 and the heat sink 248 are preferably made of steel or another material with good heat conducting properties. Furthermore, the aperture 246 and the heat sink 248 can be actively cooled. The latter favors the approach of natural convection in the small air gap. For this purpose, they may each have one or more cooling channels 247. The cooling channels can be connected to a cooling circuit via cooling fluid connections 249, in which a liquid or gaseous cooling fluid flows through the cooling channels, thereby removing heat from the aperture 246 and/or the heat sink 248.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

10 Laser cutting system
12 Laser beam source
14 Cutting gas supply
16 Workpiece support
20 Laser cutting head
21 Entry opening
22 Collimation lens
23 Deflection mirror
24 Scanner unit
241 Frame
242 Scanner mirror
243 Mirror frame
244 Drive unit
245 Sealing membrane
246 Aperture
2462 Inner wall of the aperture
247 Cooling channel
248 Heat dissipation element
249 Cooling fluid connection
25 Negative lens 26 Focusing lens
28 Exit opening
30 Workpiece
32 Kerf

L Laser beam

L_{f} Focus of the laser beam
α Deflection angle on the scanner mirror

1. A laser machining head comprising:
a scanner arranged in a beam path of the laser machining head, the scanner comprising a scanner mirror that is tiltably mounted about two rotational axes;
wherein the scanner is arranged in the laser machining head such that a laser beam which runs through the beam path is incident on the scanner mirror at an angle of incidence α of at most 30° relative to a surface normal of the scanner mirror.

2. The laser machining head according to claim 1, wherein the angle of incidence α is at most 22.5°.

3. The laser machining head according to claim 1, wherein the angle of incidence α is at most 15°.

4. The laser machining head according to claim 1, further comprising:
a collimation lens configured to collimate the laser beam entering the beam path;
a deflection mirror configured to deflect the laser beam that has been collimated by the collimation lens onto the scanner mirror such that the laser beam is incident on the scanner mirror at the angle of incidence α; and
a focusing lens configured to receive the laser beam deflected by the scanner and to focus the laser beam on a target object.

5. The laser machining head according to claim 4,
wherein the collimation lens is arranged in the laser machining head so as to be displaceable in a direction longitudinally and/or transversely to the beam path; and/or
wherein the deflection mirror is rotatably mounted in the laser machining head.

6. The laser machining head according to claim 4, further comprising:
a negative lens arranged between the scanner and the focusing lens.

7. The laser machining head according to claim 6,
wherein the negative lens is arranged in the laser machining head so as to be displaceable in a direction longitudinally to the beam path.

8. The laser machining head according to claim 1,
wherein the scanner is suspended in the laser machining head.

9. The laser machining head according to claim 4,
wherein the collimation lens is arranged upright in the laser machining head.

10. The laser machining head according to claim 1, further comprising:
a connection socket for entry of the laser beam into the beam path of the laser machining head;
wherein the connection socket is arranged horizontally or directed downwards on the laser machining head.

11. The laser machining head according to claim 1,
wherein the laser machining head is configured as a laser cutting head and comprises at least one cutting nozzle and a process gas supply, wherein the laser beam is directed together with a process gas through the cutting nozzle onto an object to be machined, and wherein the laser beam is movable through the scanner within an exit opening of the cutting nozzle.

12. A scanner for a laser machining head according to claim 1, the scanner comprising:
the scanner mirror;
a drive unit for tilting the scanner mirror about the two rotational axes; and
an aperture arranged on a reflection side of the scanner mirror, wherein the aperture has a funnel-shaped inner wall, and wherein an angle of inclination of the inner wall is at most 30° relative to the surface normal of the scanner mirror.

13. The scanner according to claim 12, wherein the aperture has an aperture opening smaller than an aperture of the scanner mirror.

14. The scanner according to claim 12, wherein the scanner mirror comprises a mirror substrate made of a transparent material.

15. The scanner according to claim 12, further comprising:
a heat dissipater arranged at a rear side of the scanner mirror, wherein the heat dissipater is spaced apart from the rear side of the scanner mirror by a gap just large enough to ensure free tilting of the scanner mirror about the rotational axes.

16. The scanner according to claim 15, wherein the aperture and/or the heat dissipater is actively cooled.

17. A laser machining system comprising:
a laser beam source for providing a laser beam; and
a laser machining head according to claim 1;
wherein the laser beam has a power of at least 0.3 kW; and
wherein a beam parameter product of the laser beam is at most 4 mm*mrad.

18. A method for laser beam cutting, the method comprising:
directing a laser beam together with a process gas through a cutting nozzle of a laser cutting head onto a surface of a workpiece to be machined,
wherein a secondary movement of the laser beam within the cutting nozzle is superimposed on a primary advance movement of the laser cutting head, and
wherein the laser beam for generating the secondary movement within the laser cutting head is directed onto a scanner mirror tiltable about two rotational axes such that an angle of incidence of the laser beam on the scanner mirror is at most 30° relative to a surface normal of the scanner mirror.
